(19) United States
(12) Patent Application Publication
(10) Pub. No.: US 2019/0313413 A1
(43) Pub. Date: Oct. 10, 2019

(54) Interlace Design For New Radio Unlicensed Spectrum Operation

(71) Applicant: MediaTek Inc., Hsinchu City (TW)

(72) Inventors: Chun-Hsuan Kuo, San Jose, CA (US); Jiann-Ching Guey, Hsinchu City (TW); Chiou-Wei Tsai, Hsinchu City (TW); Ming-Po Chang, Hsinchu City (TW)

(21) Appl. No.: 16/377,121

(22) Filed: Apr. 5, 2019

Related U.S. Application Data
(60) Provisional application No. 62/654,282, filed on Apr. 6, 2018.

(51) Int. Cl. H04W 72/04; H04L 12/24

(52) U.S. Cl. CPC H04W 72/0453; H04L 41/08

(57) ABSTRACT

Techniques and examples of interlace design for New Radio unlicensed spectrum (NR-U) operation are described. An apparatus (e.g., user equipment (UE)) assigns a plurality of resources to a plurality of interlaces such that, when the plurality of resources cannot be evenly distributed among all the plurality of interlaces, one or more remaining resources of the plurality of resources are assigned to one or more interlaces of the plurality of interlaces. The apparatus then performs an uplink (UL) transmission to a wireless network in a New Radio unlicensed spectrum (NR-U) using the plurality of resources with block interlaced frequency-division multiple access (B-IFDMA).

### CROSS REFERENCE TO RELATED PATENT APPLICATION

The present disclosure claims the priority benefit of U.S. Provisional Patent Application No. 62/654,282, filed on 6 Apr. 2018, the content of which is herein incorporated by reference in its entirety.

### TECHNICAL FIELD

The present disclosure is generally related to mobile communications and, more particularly, to interlace design for New Radio (NR) unlicensed spectrum (NR-U) operation.

### BACKGROUND

Unless otherwise indicated herein, approaches described in this section are not prior art to the claims listed below and are not admitted as prior art by inclusion in this section.

For an NR communication system operating at 5 GHz unlicensed band, the European Telecommunications Standards Institute (ETSI) regulation requires a maximum power spectral density (PSD) level of 10 dbm/MHz and an occupied channel bandwidth (OCB) of at least 80% (and up to 100%) of the nominal channel bandwidth. In Long-Term Evolution (LTE) enhanced Licensed Assisted Access (eLAA), block interlaced frequency-division multiple access (B-IFDMA) is introduced for uplink (UL) transmission in order to comply with the ETSI requirements for both OCB and maximum PSD level, while at the same time maintaining a transmit (TX) signal power level that can support a desired cell coverage.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of an apparatus assigning a plurality of resources to a plurality of interlaces such that, when the plurality of resources cannot be evenly distributed among all the plurality of interlaces, one or more remaining resources of the plurality of resources are assigned to one or more interlaces of the plurality of interlaces. The method may also involve the processor performing an UL transmission to a wireless network in an NR-U using the plurality of resources with B-IFDMA.

In one aspect, an apparatus may include a transceiver and a processor coupled to the transceiver. During operation, the transceiver may wirelessly communicate with a wireless network. During operation, the processor may perform operations including: (a) assigning a plurality of resources to a plurality of interlaces such that, when the plurality of resources cannot be evenly distributed among all the plurality of interlaces, one or more remaining resources of the plurality of resources are assigned to one or more interlaces of the plurality of interlaces; and (b) performing, via the transceiver, an UL transmission to the wireless network in an NR-U using the plurality of resources with B-IFDMA.

It is noteworthy that, although description provided herein may be in the context of certain radio access technologies, networks and network topologies such as 5G NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, and Internet-of-Things (IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example scenario in accordance with an implementation of the present disclosure.

FIG. 2 is a block diagram of an example system in accordance with an implementation of the present disclosure.

FIG. 3 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

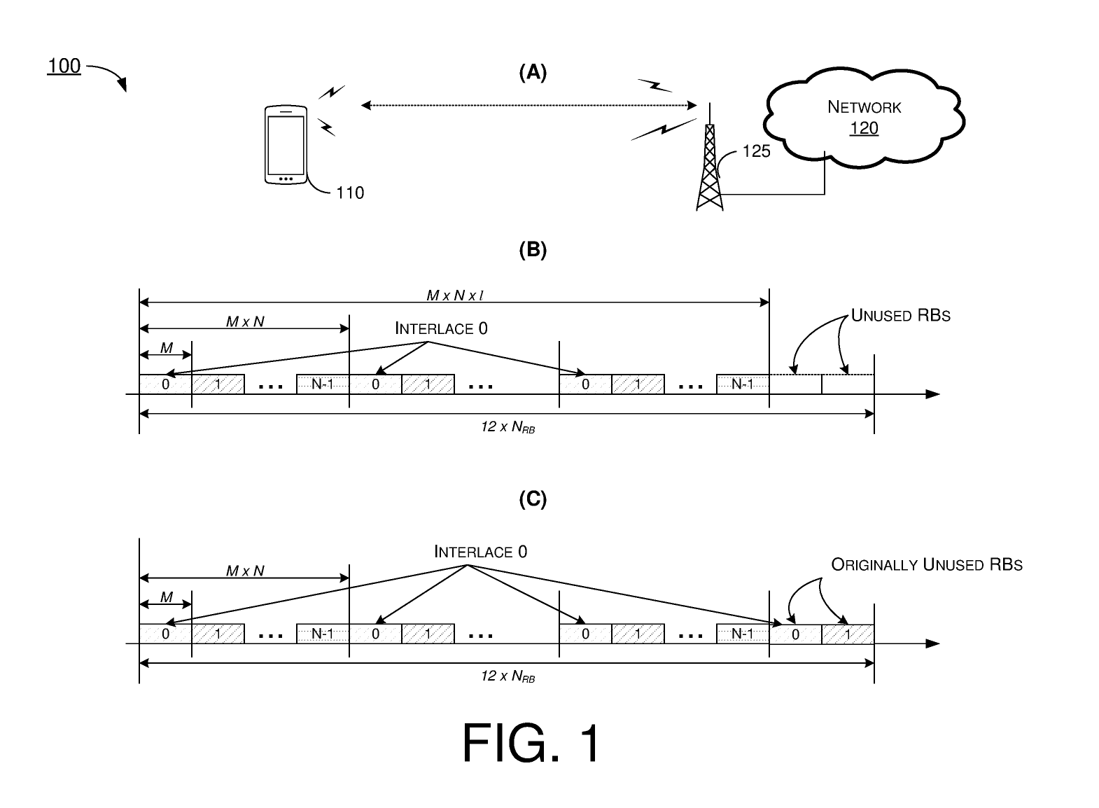

FIG. 1 illustrates an example scenario 100 in accordance with an implementation of the present disclosure. Referring to part (A) of FIG. 1, scenario 100 may involve a user equipment (UE) 110 in wireless communication in NR-U with a wireless network 120 (e.g., a 5th-Generation (5G) NR mobile network) via a base station or network node 125 (e.g., a gNB or transmit-receive point (TRP)). In scenario 100, UE 110 may perform wireless communications with wireless network 120 via base station 125 using interlace design for NR-U operation based on one or more of various proposed schemes in accordance with the present disclosure. The follow description of one proposed scheme in accordance with the present disclosure is provided with reference to part (A), part (B) and part (C) of FIG. 1.

Referring to part (B) of FIG. 1, current eLAA B-IFDMA design involves some key parameters denoted herein as M, l, N and N_{RB}. Here, M denotes a number of subcarriers per block (e.g., M=12 for eLAA), l denotes a number of blocks per interlace (e.g., l=10 for eLAA), N denotes a number of interlaces per symbol (e.g., N=10 for eLAA), and N_{RB} denotes a total number of resource blocks (RBs) per symbol (e.g., N_{RB}=100 for eLAA). However, when N_{RB} is not an integer multiple of N, there would be one or more remaining RBs that is/are not used, thereby reducing efficiency in resource utilization. Moreover, the current eLAA B-IFDMA design cannot be applied to arbitrary orthogonal frequency-division multiplexing (OFDM) numerologies while still meeting the OCB requirements.

Mathematically, B-IFDMA mapping under the current eLAA B-IFDMA design can be expressed as follows:

S(n)={M(Nl+n)+m|0≤m<M, 0≤l<floor(N_{RB}/N)}

Under a proposed scheme in accordance with the present disclosure, a new B-IFDMA mapping may be utilized such that all available RBs may be used to construct interlaces. Moreover, under the proposed scheme, it may be guaranteed that each interlace would meet the OCB requirements. Referring to part (C) of FIG. 1, a new B-IFDMA mapping under the proposed scheme may assign all remaining RBs (if any) to one or more of the existing interlaces. The assignment may be based on a predefined rule or pattern. Alternatively, the assignment may be dynamically configured by a wireless network. That is, remaining Q RBs may be assigned to first Q interlaces. For instance, given a total of 106 resources to be assigned to 10 interlaces, after each interlace having been assigned 10 resources there would be 6 resources remaining. Under the proposed scheme, the 6 remaining resources may be assigned to first 6 of the 10 interlaces. As a result, each of the first 6 interlaces would be assigned with 11 resources while each of the remaining 4 interlaces would be assigned with 10 resources.

Mathematically, B-IFDMA mapping under the proposed scheme may be expressed as follows:

s₁(n)={M(Nl+n)+m|0≤m<M, 0≤l≤(N_{RB}−n−1)/N}

Under the proposed scheme, B-IFDMA design criteria for compliance with the OCB requirement may be expressed as follows:

$${B}_{o} = M \times ( ( floor ( \frac{12 \times {N}_{RB}}{M \times N} ) - 1 ) \times N + 1 ) \times Δ f / B$$

Here, Δf denotes subcarrier spacing, and B denotes a nominal channel bandwidth. Under the proposed scheme, in view of the OCB requirement, Bₒ needs to be greater than γ(e.g., γ=0.8, with γ representative of OCB).

Under the proposed scheme, there may be some design criteria for N. For instance, the value of M may be chosen first (e.g., M=12 for RB-based interlace design) and Bₒ(N) may be plotted for N=1 to (12×N_{RB}/M), then the maximum value of N may be determined such that Bₒ(N)>γ.

Under the proposed scheme, there may be some design criteria for M. For instance, the value of N may be chosen first (e.g., N=10 for ten interlaces) and Bₒ(M) may be plotted for M in a range of interest, then the maximum value of M may be determined such that Bₒ(M)>γ.

Thus, under the proposed scheme, with respect to resource mapping in B-IFDMA design, remaining resources may be assigned to a subset of all interlaces via a predefined or dynamic configuration when available resources cannot be evenly distributed among all interlaces. With respect to the design criteria for OCB compliance, a close form formula may be provided for OCB computation. Additionally, based on the formula, OCB may be evaluated as a function of various design parameters so as to select proper values for the design parameters to satisfy the OCB requirement.

### Illustrative Implementations

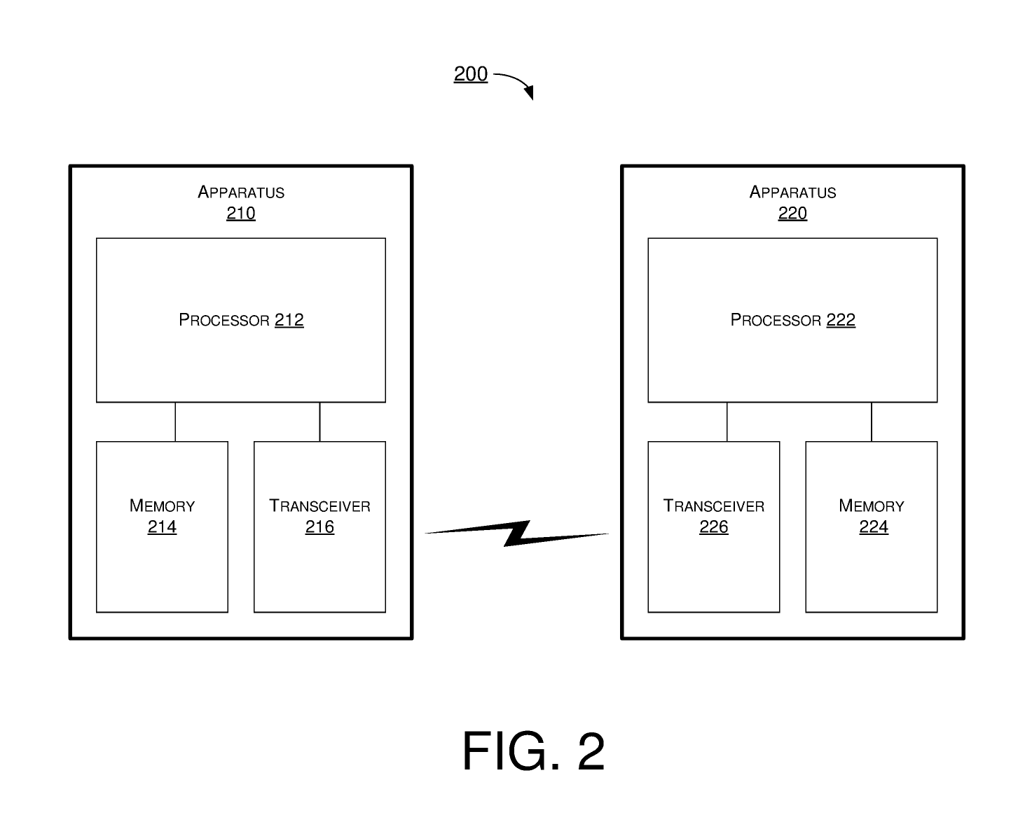

FIG. 2 illustrates an example system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to interlace design for NR-U operation, including the various schemes described above with respect to various proposed designs, concepts, schemes, systems and methods described above as well as process 200 described below. For instance, apparatus 210 may be an example implementation of UE 110, and apparatus 220 may be an example implementation of base station 125.

Each of apparatus 210 and apparatus 220 may be a part of an electronic apparatus, which may be a network apparatus or a UE (e.g., UE 110), such as a portable or mobile apparatus, a wearable apparatus, a wireless communication apparatus or a computing apparatus. For instance, each of apparatus 210 and apparatus 220 may be implemented in a smartphone, a smart watch, a personal digital assistant, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in a base station (e.g., base station 125), such as an eNB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, or one or more complex-instruction-set-computing (CISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to interlace design for NR-U operation in accordance with various implementations of the present disclosure.

In some implementations, apparatus 210 may also include a transceiver 216 coupled to processor 212. Transceiver 216 may be capable of wirelessly transmitting and receiving data. In some implementations, apparatus 220 may also include a transceiver 226 coupled to processor 222. Transceiver 226 may include a transceiver capable of wirelessly transmitting and receiving data.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE, and apparatus 220, as a base station of a serving cell of a wireless network (e.g., 5G/NR mobile network), is provided below. It is noteworthy that, although the example implementations described below are provided in the context of a UE, the same may be implemented in and performed by a base station. Thus, although the following description of example implementations pertains to apparatus 210 as a UE (e.g., UE 110), the same is also applicable to apparatus 220 as a network node or base station such as a gNB, TRP or eNodeB (e.g., base station 125) of a wireless network (e.g., wireless network 120) such as a 5G NR mobile network.

Under a proposed scheme with respect to interlace design for NR-U operation in accordance with the present disclosure, processor 212 of apparatus 210 may assign a plurality of resources to a plurality of interlaces such that, when the plurality of resources cannot be evenly distributed among all the plurality of interlaces, one or more remaining resources of the plurality of resources are assigned to one or more interlaces of the plurality of interlaces. Moreover, processor 212 may perform, via transceiver 216, an UL transmission to a wireless network via apparatus 220 in an NR-U using the plurality of resources with B-IFDMA.

In some implementations, in assigning, processor 212 may assign according to a predefined configuration.

In some implementations, in assigning, processor 212 may perform some operations. For instance, processor 212 may dynamically receive a configuration from the wireless network via apparatus 220. Additionally, processor 212 may assign the plurality of resources to the plurality of interlaces according to the configuration received from the wireless network.

In some implementations, in assigning the plurality of resources to the plurality of interlaces, processor 212 may assign the plurality of resources to the plurality of interlaces to satisfy an occupied channel bandwidth (Bₒ) requirement such that:

$${B}_{o} = M \times ( ( floor ( \frac{12 \times {N}_{RB}}{M \times N} ) - 1 ) \times N + 1 ) \times Δ f / B$$

Here, Δf may denote a subcarrier spacing, B may denote a nominal channel bandwidth, M may denote a number of subcarriers per block, N may denote a number of interlaces per symbol, and N_{RB} may denote a total number of resource blocks (RBs) per symbol.

In some implementations, in assigning the plurality of resources to the plurality of interlaces, processor 212 may perform some operations. For instance, processor 212 may select a value for M. Additionally, processor 212 may plot Bₒ(N) for N=1 to (12×N_{RB}/M). Moreover, processor 212 may determine a maximum value of N such that B₀(N)>γ. In some implementations, γ=0.8.

In some implementations, in assigning the plurality of resources to the plurality of interlaces, processor 212 may perform some operations. For instance, processor 212 may select a value for N. Moreover, processor 212 may plot Bₒ(M) for M in a range of interest. Furthermore, processor 212 may determine a maximum value of M such that Bₒ(M)>γ. In some implementations, γ=0.8.

In some implementations, in performing the UL transmission to the wireless network in the NR-U, processor 212 may perform the UL transmission to the wireless network in the NR-U with an OCB of at least 80%.

In some implementations, in performing the UL transmission to the wireless network in the NR-U, processor 212 may perform the UL transmission to the wireless network in the NR-U with a maximum PSD level no more than 10 dbm/MHz.

### Illustrative Processes

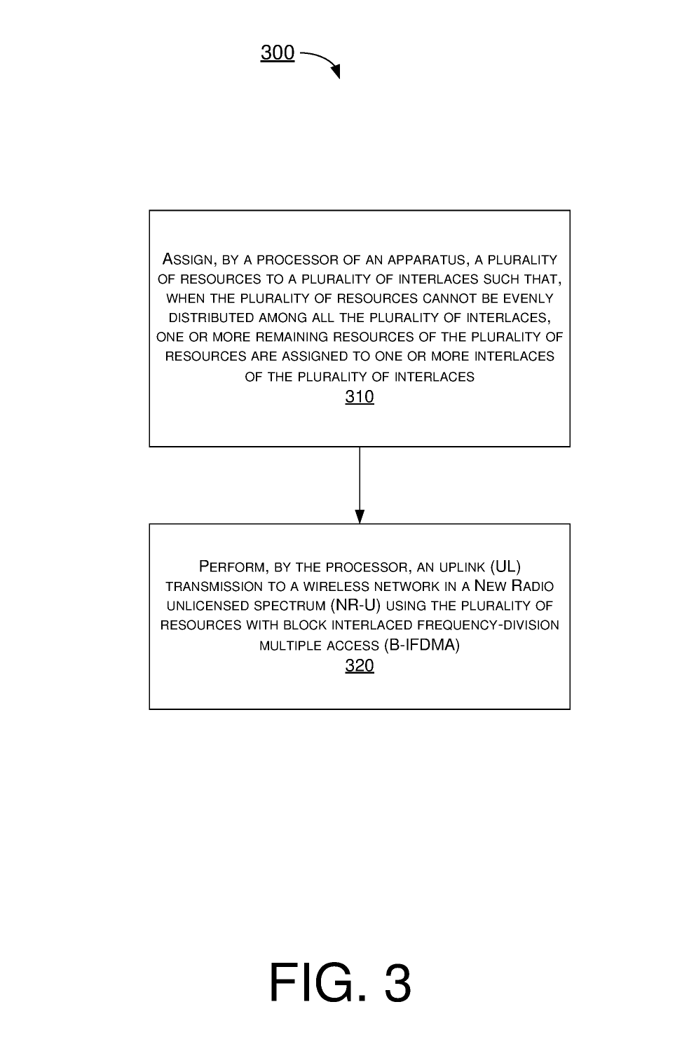

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to interlace design for NR-U operation. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a base station (e.g., base station 125) of a wireless network (e.g., wireless network 120) such as a 5G/NR mobile network. Process 300 may begin at block 310.

At 310, process 300 may involve processor 212 of apparatus 210 assigning a plurality of resources to a plurality of interlaces such that, when the plurality of resources cannot be evenly distributed among all the plurality of interlaces, one or more remaining resources of the plurality of resources are assigned to one or more interlaces of the plurality of interlaces. Process 300 may proceed from 310 to 320.

At 320, process 300 may involve processor 212 performing, via transceiver 216, an UL transmission to a wireless network via apparatus 220 in an NR-U using the plurality of resources with B-IFDMA.

In some implementations, in assigning, process 300 may involve processor 212 assigning according to a predefined configuration.

In some implementations, in assigning, process 300 may involve processor 212 performing some operations. For instance, process 300 may involve processor 212 dynamically receiving a configuration from the wireless network via apparatus 220. Additionally, process 300 may involve processor 212 assigning the plurality of resources to the plurality of interlaces according to the configuration received from the wireless network.

In some implementations, in assigning the plurality of resources to the plurality of interlaces, process 300 may involve processor 212 assigning the plurality of resources to the plurality of interlaces to satisfy an occupied channel bandwidth (Bₒ) requirement such that:

$${B}_{o} = M \times ( ( floor ( \frac{12 \times {N}_{RB}}{M \times N} ) - 1 ) \times N + 1 ) \times Δ f / B$$

Here, Δf may denote a subcarrier spacing, B may denote a nominal channel bandwidth, M may denote a number of subcarriers per block, N may denote a number of interlaces per symbol, and N_{RB} may denote a total number of resource blocks (RBs) per symbol.

In some implementations, in assigning the plurality of resources to the plurality of interlaces, process 300 may involve processor 212 performing some operations. For instance, process 300 may involve processor 212 selecting a value for M. Additionally, process 300 may involve processor 212 plotting Bₒ(N) for N=1 to (12×N_{RB}/M). Moreover, process 300 may involve processor 212 determining a maximum value of N such that Bₒ(N)>γ. In some implementations, γ=0.8.

In some implementations, in assigning the plurality of resources to the plurality of interlaces, process 300 may involve processor 212 performing some operations. For instance, process 300 may involve processor 212 selecting a value for N. Moreover, process 300 may involve processor 212 plotting Bₒ(M) for M in a range of interest. Furthermore, process 300 may involve processor 212 determining a maximum value of M such that Bₒ(M)>γ. In some implementations, γ=0.8.

In some implementations, in performing the UL transmission to the wireless network in the NR-U, process 300 may involve processor 212 performing the UL transmission to the wireless network in the NR-U with an OCB of at least 80%.

In some implementations, in performing the UL transmission to the wireless network in the NR-U, process 300 may involve processor 212 performing the UL transmission to the wireless network in the NR-U with a maximum PSD level no more than 10 dbm/MHz.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
assigning, by a processor of an apparatus, a plurality of resources to a plurality of interlaces such that, when the plurality of resources cannot be evenly distributed among all the plurality of interlaces, one or more remaining resources of the plurality of resources are assigned to one or more interlaces of the plurality of interlaces; and
performing, by the processor, an uplink (UL) transmission to a wireless network in a New Radio unlicensed spectrum (NR-U) using the plurality of resources with block interlaced frequency-division multiple access (B-IFDMA).

2. The method of claim 1, wherein the assigning comprises assigning according to a predefined configuration.

3. The method of claim 1, wherein the assigning comprises:
dynamically receiving a configuration from the wireless network; and
assigning the plurality of resources to the plurality of interlaces according to the configuration received from the wireless network.

4. The method of claim 1, wherein the assigning of the plurality of resources to the plurality of interlaces comprises assigning the plurality of resources to the plurality of interlaces to satisfy an occupied channel bandwidth (Bₒ) requirement such that:
$${B}_{o} = M \times ( ( floor ( \frac{12 \times {N}_{RB}}{M \times N} ) - 1 ) \times N + 1 ) \times Δ f / B$$
wherein:
Δf denotes a subcarrier spacing,
B denotes a nominal channel bandwidth,
M denotes a number of subcarriers per block,
N denotes a number of interlaces per symbol, and
N_{RB} denotes a total number of resource blocks (RBs) per symbol.

5. The method of claim 4, wherein the assigning of the plurality of resources to the plurality of interlaces further comprises:
selecting a value for M;
plotting Bₒ(N) for N=1 to (12×N_{RB}/M); and
determining a maximum value of N such that Bₒ(N)>γ.

6. The method of claim 5, wherein γ=0.8.

7. The method of claim 4, wherein the assigning of the plurality of resources to the plurality of interlaces further comprises:
selecting a value for N;
plotting Bₒ(M) for M in a range of interest; and
determining a maximum value of M such that Bₒ(M)>γ.

8. The method of claim 7, wherein γ=0.8.

9. The method of claim 1, wherein the performing of the UL transmission to the wireless network in the NR-U comprises performing the UL transmission to the wireless network in the NR-U with an occupied channel bandwidth (OCB) of at least 80%.

10. The method of claim 1, wherein the performing of the UL transmission to the wireless network in the NR-U comprises performing the UL transmission to the wireless network in the NR-U with a maximum power spectral density (PSD) level no more than 10 dbm/MHz.

11. An apparatus, comprising:
a transceiver which, during operation, wirelessly communicates with a wireless network; and
a processor coupled to the transceiver such that, during operation, the processor performs operations comprising:
assigning a plurality of resources to a plurality of interlaces such that, when the plurality of resources cannot be evenly distributed among all the plurality of interlaces, one or more remaining resources of the plurality of resources are assigned to one or more interlaces of the plurality of interlaces; and
performing, via the transceiver, an uplink (UL) transmission to the wireless network in a New Radio unlicensed spectrum (NR-U) using the plurality of resources with block interlaced frequency-division multiple access (B-IFDMA).

12. The apparatus of claim 11, wherein, in assigning, the processor assigns according to a predefined configuration.

13. The apparatus of claim 11, wherein, in assigning, the processor performs operations comprising:
dynamically receiving a configuration from the wireless network; and
assigning the plurality of resources to the plurality of interlaces according to the configuration received from the wireless network.

14. The apparatus of claim 11, wherein, in assigning the plurality of resources to the plurality of interlaces, the processor assigns the plurality of resources to the plurality of interlaces to satisfy an occupied channel bandwidth (Bₒ) requirement such that:
$${B}_{o} = M \times ( ( floor ( \frac{12 \times {N}_{RB}}{M \times N} ) - 1 ) \times N + 1 ) \times Δ f / B$$
wherein:
Δf denotes a subcarrier spacing,
B denotes a nominal channel bandwidth,
M denotes a number of subcarriers per block,
N denotes a number of interlaces per symbol, and
N_{RB} denotes a total number of resource blocks (RBs) per symbol.

15. The apparatus of claim 14, wherein, in assigning the plurality of resources to the plurality of interlaces, the processor further performs operations comprising:
selecting a value for M;
plotting Bₒ(N) for N=1 to (12×N_{RB}/M); and
determining a maximum value of N such that Bₒ(N)>γ.

16. The apparatus of claim 15, wherein γ=0.8.

17. The apparatus of claim 14, wherein, in assigning the plurality of resources to the plurality of interlaces, the processor further performs operations comprising:
selecting a value for N;
plotting Bₒ(M) for M in a range of interest; and
determining a maximum value of M such that Bₒ(M)>γ.

18. The apparatus of claim 17, wherein γ=0.8.

19. The apparatus of claim 11, wherein, in performing the UL transmission to the wireless network in the NR-U, the processor performs the UL transmission to the wireless network in the NR-U with an occupied channel bandwidth (OCB) of at least 80%.

20. The apparatus of claim 11, wherein, in performing the UL transmission to the wireless network in the NR-U, the processor performs the UL transmission to the wireless network in the NR-U with a maximum power spectral density (PSD) level no more than 10 dbm/MHz.
